(19) United States
(12) Patent Application Publication
(10) Pub. No.: US 2010/0067335 A1
(43) Pub. Date: Mar. 18, 2010

(54) METHOD AND APPARATUS FOR ERROR CORRECTION OF OPTICAL DISC DATA

(75) Inventors: Mo Li, Shanghai (CN); Dahua He, Shanghai (CN); Jin Wang, Shanghai (CN); Yang Peng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,547

(22) PCT Filed: Dec. 8, 2005
(86) PCT No.: PCT/IB2005/054112

§ 371 Date: Oct. 28, 2009

(30) Foreign Application Priority Data
Dec. 21, 2004 (CN) 200410104973.6

(51) Int. Cl. G11B 20/10

(52) U.S. Cl. 369/47.14; G9B/20.046

(57) ABSTRACT

A method and device for error correction of data in an optical disc is provided in the present invention. The method comprises the following steps: obtaining the description information about the error data read from an optical disc; sending request information for error correction, based on the description information, to a network server, where the network server stores the backup data corresponding to the data on the optical disc and the request information for error correction comprises the request for downloading the backup data corresponding to the error data; and replacing the error data with the downloaded backup data, so as to play the optical disc correspondingly. The method and device provided in the present invention can repair data error of various kinds and provide a playing effect of equal quality with the expected playing effect when data is not damaged.

### FIELD OF THE INVENTION

The present invention relates to the field of optical disc playing technology, and more particularly, to a method and apparatus for error correction of data in an optical disc. The optical disc, unlike the magnetic disk that is under the protection of a protection case, is inevitable to suffer various damages, as a result, markings, such as scratch, smudge, distortion and the like, which will influence the reading of optical disc data, are formed on the disc surface. These markings are likely to lead to incorrectly reading of optical disc data by an optical disc playing apparatus, and even lead to failure in reading optical disc data. Therefore, in the field of optical storage technology, error correction of optical disc data read from a damaged optical disc is a research subject of vital importance.

### BACKGROUND OF THE INVENTION

In the prior art, error correction of optical disc data is generally achieved by error correction algorithm. For example, an ECC (Error Correction Code) data block is on-line error corrected at the front end of optical disc playing apparatus. If the data read from an optical disc contains some bytes of damaged data, the damaged data can be deduced and recovered based on the adjacent data that is not damaged, or can be directly replaced by fuzzy data (e.g. mosaic data), so that the playing of the optical disc could continue without disruption.

In general, one kind of error correction algorithm is applicable to a specific type of data error, but it is impossible for an optical disc playing apparatus to install all types of the error correction algorithm, so it will naturally be difficult for the local resources for error correction to deal with various kinds of optical disc data error. To complement the insufficiency of error correction algorithm, the existing network optical disc playing apparatus may search for appropriate error correction algorithm by linking to network to process the corresponding optical disc data error at the corresponding place. However, said network error correction technique still can not avoid the limitation of error correction algorithm, since besides being applicable to specific types of data error, error correction algorithm usually is only suitable for the case where the amount of damaged data is small, and said error correction algorithm will bemoan its inadequacy when faced with the case where large segments of continuous data are damaged. Furthermore, the data deduced and recovered based on error correction algorithm usually can not be recovered to the original status completely, so the playing effect of the optical disc can hardly reach the expected extent.

As for the measure to replace the damaged data with fuzzy data, when there are few damaged data, the slight jumping and discontinuity of optical disc playing frame will not influence the playing effect as a whole. However, when there are great deals of damaged data and large segments of data are replaced by mosaic data, the playing effect will be greatly deteriorated.

As mentioned above, neither deducing the damaged data by error correction algorithm nor replacing the damaged data with fuzzy data can ensure the recovery of optical disc data to a perfect extent. The corresponding playing effect of an optical disc will inevitably be affected, and especially when optical disc data is seriously damaged, the optical disc may not be played.

Therefore, it is required to provide a method and device for error correction of optical disc data, in order to repair data error of various kinds and provide a playing effect equal to the expected playing effect that can be obtained when data is not damaged.

### OBJECT AND SUMMARY OF THE INVENTION

An object of the present invention is to provide a method and device for error correction of optical disc data in order to overcome the drawbacks in the prior art.

According to an embodiment of the present invention, a method for error correction of optical disc data is provided which comprises the steps of: obtaining the description information about the error data read from an optical disc; sending request information for error correction, based on said description information, to a network server, where the backup data corresponding to the data on said optical disc being stored in said network server and said request information for error correction comprising the request for downloading the backup data corresponding to said error data; and correspondingly replacing said error data with said downloaded backup data, so as to play said optical disc with said downloaded backup data.

According to an embodiment of the present invention, an device for error correction of optical disc data is provided which comprises: obtaining means used to obtain the description information about the error data read from an optical disc; requesting means used to send request information for error correction to a network server based on said description information, where the backup data corresponding to the data on said optical disc being stored in said network server and said request information for error correction comprising a request for downloading the backup data corresponding to said error data; and replacing means used to correspondingly replace said error data with said downloaded backup data, so as to play said optical disc with said downloaded backup data.

Other objects and achievements of the present invention and a complete appreciation of the invention will become apparent from the following description of the present invention and appended claims with reference to the accompanying drawings.

### BRIEF DESCRIPTION OF THE DRAWINGS

The present invention will be explained in details by way of embodiments with reference to the accompanying drawings.

FIG. 1 illustrates a schematic view of the structure of an optical disc playing system in accordance with an embodiment of the present invention;

FIG. 2 is a flow chart illustrating a method for error correction of optical disc data in accordance with an embodiment of the present invention;

FIG. 3 is a block diagram of a device for error correction of optical disc data in accordance with an embodiment of the present invention;

FIG. 4 is a block diagram illustrating an optical disc playing apparatus in accordance with an embodiment of the present invention; and

FIG. 5 is a block diagram illustrating an optical disc playing apparatus in accordance with an embodiment of the present invention.

Throughout the above accompanying drawings, like reference symbols indicate the same, similar or corresponding features and functions.

### DETAILED DESCRIPTION OF THE INVENTION

With the development of the network technology, network servers can absolutely establish data backup for distributed optical discs, and can also transfer large amount of data to a client under the permission of the data transfer bandwidth and the time. In view of this, the present invention is based upon the following conception: first of all, the description information about the damaged data in the optical disc, e.g. storage address of the error data or the period of time during which it is played (address information, for wrong ECC block), etc., is obtained; then a request for downloading the backup data corresponding to the error data is sent to a network server, and the backup data will be used to replace the error data read from the optical disc. The downloaded backup data in connection with the correct data read from the optical disc will simultaneously be transferred for corresponding processing so as to play the optical disc. By means of said technical scheme, the integrality and accuracy of the optical disc data will be guaranteed and the playing effect of the optical disc will be equal to that can be obtained when the data in the optical disc is not damaged.

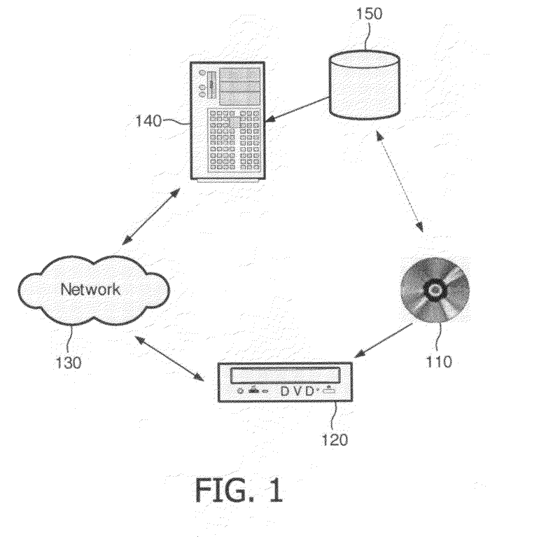

FIG. 1 illustrates a schematic view of an optical disc playing system according to an embodiment of the present invention. The optical disc 110 has unique identification information (ID). With said identification information, the optical disc service suppliers can determine whether they themselves distributed the optical disc 110 or whether they should provide services. Optical disc 110 also includes the network link information of the optical disc service supplier who will provide service for the use of said optical disc 110. With the corresponding network link information, optical disc playing apparatus 120 (network optical disc playing apparatus, such as blue ray optical disc player and so forth) can link to the corresponding network server to exchange corresponding information and data.

When the optical disc 110 is inserted into the optical disc playing apparatus 120, the apparatus 120 will read the data information in the optical disc 110 and will perform error detection in the optical disc data that has been read out.

Once error is detected on the read optical disc data and said data error goes beyond the repairing capability of local resources for error correction (e.g. the local or downloaded error correction algorithm), for example, the optical disc data is damaged too severely to be read, the optical disc playing apparatus 120 will link to the network server 140 via the network 130 and request to download the backup data corresponding to the damaged data in the optical disc 110, based on the link information of the optical disc service supplier provided in the optical disc 110, to repair the damaged data.

When receiving the error correction request from the optical disc playing apparatus 120, the network server 140 will identify the optical disc 110 according to the identification information (ID) of the optical disc, and then determine whether services should be provided for said optical disc 110. If the optical disc 110 belongs to the optical discs for which services should be provided, server 140 will retrieve the database corresponding to the optical disc 110 in the optical disc data backup database 150, and then based on the request from user side, i.e. optical disc playing apparatus 120, send the backup data corresponding to the error data. Optical disc service suppliers will charge the users accordingly based on the request of user side and the service offered.

The optical disc playing apparatus 120 replaces the damaged error data read from the optical disc with the received backup data, and the received backup data together with the correct data read from the optical disc, the error data which can be repaired by the local resources for error correction and the like will then be processed in order to play the optical disc. The data that can be repaired by local resources for error correction includes the error data that can not be detected by the detecting means for error detection at the corresponding place.

The backup data which the users request to download for error correction may vary in volume depending on the damage degree of the optical disc and the error correction capability of optical disc playing apparatus at user side. If the data to be transferred is relatively large in volume while the bandwidth is quite narrow, the backup data may not be downloaded at the same pace with the playing of said optical disc, which may influence the playing effect and may lead to discontinuously playing. Therefore, a buffer can be set at the user side, i.e. at the optical disc playing apparatus 120, to download optical disc data in advance, so that the backup data for replacing the error data can be downloaded to said buffer in advance as backup so as not to affect the playing procedure of the optical disc.

By means of the foregoing measure, even when the data needed to be downloaded is large in volume and the bandwidth is not quite abundant, the playing effect of the optical disc still can be guaranteed.

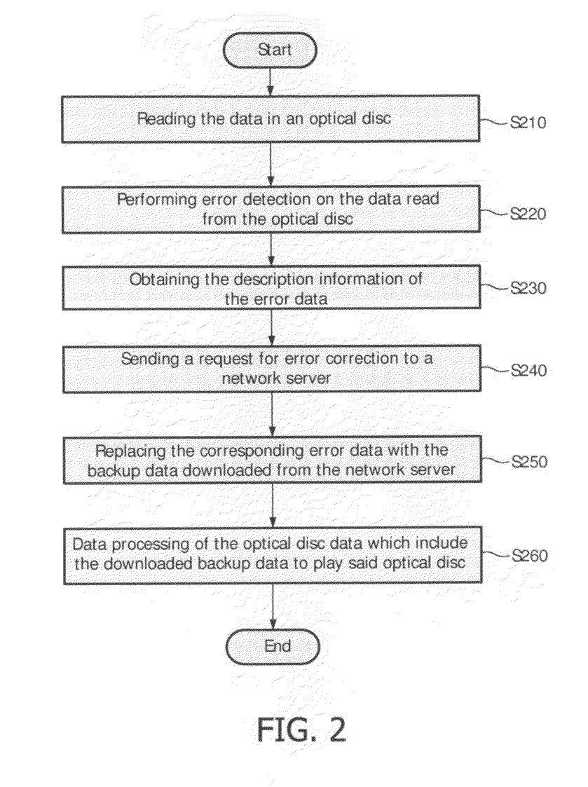

FIG. 2 is a flow chart illustrating a method for error correction of optical disc data according to an embodiment of the present invention. Firstly, optical disc playing apparatus will read the data in an optical disc (Step S210). The optical disc data that read from the optical disc by the driving means in the optical disc playing apparatus are usually ECC (Error Correction Code) data blocks. An ECC block is a data block to which a check code is added after the program data is compressed, and it enables the error correction of the data during the period of transferring, wherein a certain fault tolerance is allowed.

Then, error detection is performed on the data read from the optical disc (Step S220). Since the ECC data blocks read by the front end of the optical disc playing apparatus can be corrected online based on the check code therein, once any error is detected in an ECC data block and if said error falls into the allowable range of the ECC fault tolerance, the driving means of said optical disc playing apparatus will perform online error correction on the ECC block and label the corrected ECC block as the correct data. However, an ECC block with error exceeding its fault tolerance will be labeled as error data. According to the conventional method, if an ECC block is labeled as a error data block, said data block will be discarded directly, but it will be repaired by means of replacement in the present invention.

Then, according to the detected error data, the optical disc playing apparatus will obtain the description information about said error data (Step S230). Each ECC data block labeled as error data has its unique identification information such as starting address, ending address and the like. Said labeling information can be used to identify said ECC data block and the compressed program data corresponding to said ECC data block.

Then, the optical disc playing apparatus sends request information for error correction to the corresponding network server (Step S240), based on the network link information of the network service supplier provided in the optical disc, wherein said request information comprises the identification information (ID) of the optical disc, the link information of the optical disc playing apparatus, the description information about the error data, the request for downloading the backup data corresponding to said error data so as to replace said error data, and the like. The network link information of the network service supplier can also be stored in other media, e.g. on the package specification of an optical disc and the like. The description information about the error data includes the labeling information of an ECC data block and the like. If the customer should be charged for the corresponding network error correction, the corresponding network request information for error correction should also include the payment details and the like.

The corresponding network server will send the backup data corresponding to the error data to optical disc playing apparatus based on the request for error correction.

Optical disc playing apparatus will replace the error data with the corresponding received backup data (Step S250). The received backup data can be buffering in the optical disc playing apparatus before all, so as to ensure the seamless playing of the optical disc.

Finally, the optical disc playing apparatus will play the optical disc based on the backup data downloaded from the network as well as the correct data read from the optical disc (Step S260). The backup data and the correct data read from the optical disc will be decompressed, and then accordingly decoded to obtain program data stream for outputting the program.

The method of error correction by downloading the backup data from the network is not limited to the error which can not be repaired locally, and it is also viable for the error data which can be repaired locally, for example, in the case when the effect and speed of error reparation by local resources for error correction can not satisfy the playing requirements of an optical disc.

By means of the foregoing method, the playing effect of an optical disc can be guaranteed in the case where the data therein is damaged and the reparation can not be performed or the reparation effect is unsatisfactory, and good playing effect of the optical disc can be guaranteed.

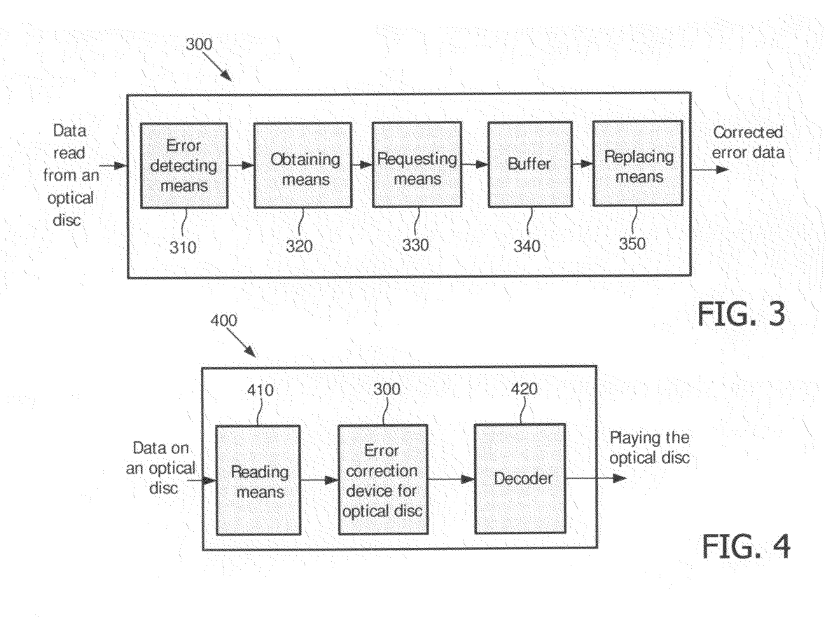

FIG. 3 is a block diagram of a device 300 for error correction of optical disc data according to an embodiment of the present invention. As shown in FIG. 3, error correction device 300 comprises error detecting means 310 for error detection of the data read from an optical disc. ECC data blocks exceeding the fault tolerance will be labeled as error data by the front end of the optical disc playing apparatus.

The error correction device 300 further comprises obtaining means 320 for obtaining the description information about the error data. If an ECC data block error is detected by the error detecting means 310, means 320 will obtain the description information about the error data, such as starting address, ending address and the period of time during which said error data is played.

If the error correction via network is not free, the local resources for error correction should be used as much as possible for error correction so as to reduce the users' expense. However, when the poor error repairing effect and long repairing time exert an influence on the playing effect, it is recommended to correct the error via the network.

The error correction device 300 further comprises requesting means 330. The requesting means 330 will send request information for error correction, based on the detected description information about the error data, to the network server of the optical disc content service supplier. The request information for error correction includes the identification information (ID) of the optical disc, the link information of the optical disc playing apparatus and the description of the error data. The request information for error correction may further include the request for downloading backup data corresponding to the error data for error correction, and the payment details, etc. when it should be charged for the error correction.

The error correction device 300 further comprises a buffer 340. The data for error correction downloaded from the network may be quite large in volume, or the bandwidth for transferring data may be rather narrow, so that the data for error correction can not be processed with the same speed as the data read directly from the optical disc. Therefore, the data for error correction downloaded from the network can be downloaded in advance to the buffer 340 before being processed for playing, in order to ensure the seamless playing of the optical disc. The data for error correction can be downloaded during playing, but it must be guaranteed that the corresponding data for error correction have been stored in the buffer 340 when they are needed in playing process.

The error correction device 300 further comprises replacing means 350 for replacing the corresponding error data with the downloaded error correction data. To make sure that the data can be normally processed for playing, the error data should not be transferred and instead, the downloaded backup data, the correct data read from the optical disc, as well as the error data which can be repaired by local resources for error correction should be transferred, so the error data should be replaced with the downloaded error correction data before it is transferred.

By means of the foregoing device 300, the error correction capability of an optical disc playing apparatus can be enhanced, and the repaired data can be recovered to the undamaged status. The backup data downloaded from the network can be stored in the optical disc playing apparatus for subsequent playing.

FIG. 4 is a block diagram illustrating the optical disc playing apparatus 400 according to an embodiment of the present invention. Data in an optical disc is read from the optical disc by the reading meanings 410 of the optical disc playing apparatus 400. After the optical disc data is error corrected by error correction device 300 via network, it is decoded in the decoder 420 and finally used to playing the optical disc.

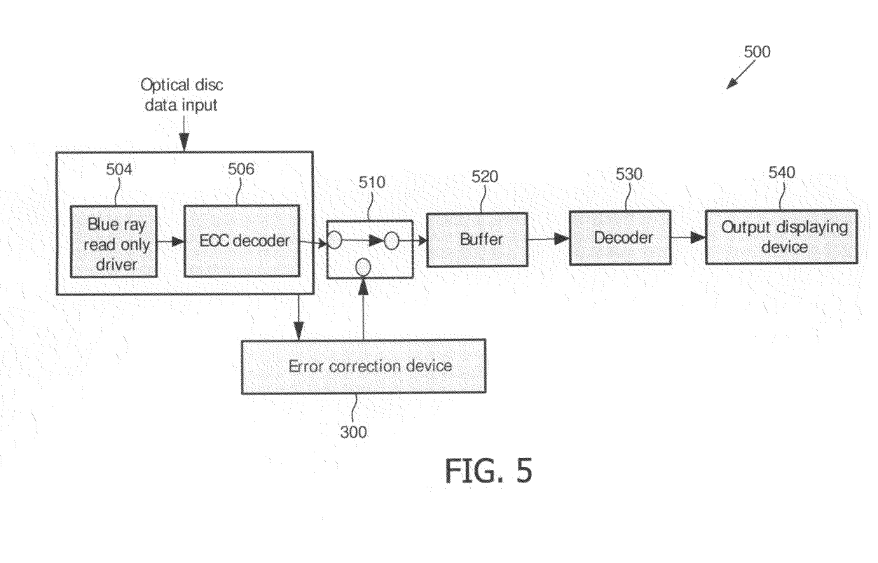

FIG. 5 is a block diagram illustrating the optical disc playing apparatus 500 that carries out network replacement error correction at the front end, according to an embodiment of the present invention. Hereafter, the description is made on the example of blue ray optical disc player. The data on the blue ray optical disc is read by the driver 504 of blue ray optical disc player, and the ECC data blocks read therefrom are decoded in the ECC decoder 506.

After the ECC data blocks are decoded, error correction will be performed on the wrong ECC data blocks by error correction device 300 via network. The compressed backup data of the program downloaded from the network will be transferred together with the correct data from the optical disc via switching means 510 and experience the processing of decoding and the like so as to play the optical disc. The switching means 510 in FIG. 5 may be a part of the replacing means 350 in device 300, and be used to replace the error data with the backup data downloaded from the network.

After the error-corrected data passes through the buffer 520, it will be decoded by data decoder 530, for example, the decoding of the MPEG compressed data, and finally the decoded data will be transferred to the output displaying device 540 to play the corresponding programs.

While the present invention has been described with reference to the preferred embodiments, it will be apparent for those skilled in the art that various substitutions, modifications and changes may be made according to the content described above, and therefore, all these substitutions, modifications and changes should fall into the spirit and scope of the appended claims of the invention.

1. A method for error correction of optical disc data, comprising the steps of:
a) obtaining a description information about error data read from an optical disc;
b) sending a request information for error correction, based on said description information, to a network server, wherein said network server stores the backup data corresponding to the data on said optical disc and said request information for error correction comprises a request for downloading the backup data corresponding to said error data; and
c) replacing said error data with said downloaded backup data corresponding to said error data, so as to play said optical disc with said downloaded backup data.

2. The method according to claim 1, wherein said request information for error correction includes the identification information of said optical disc.

3. The method according to claim 2, wherein said description information comprises at least one of the starting address of said error data, the ending address of said error data, and the period of time during which said error data is played.

4. The method according to claim 1, wherein a link information of said network server is stored on said optical disc.

5. The method according to claim 1, further comprising the step of:
d) buffer-storing the downloaded backup data.

6. An apparatus for error correction of optical disc data, comprising:
obtaining means, for obtaining the description information about the error data read from an optical disc;
requesting means, for sending request information for error correction, based on said description information, to a network server, wherein said network server stores the backup data corresponding to the data in said optical disc and said request information for error correction comprises a request for downloading the backup data corresponding to said error data; and
replacing means for replacing said error data with said downloaded backup data corresponding to said error data, for playing said optical disc with said downloaded backup data.

7. The apparatus according to claim 6, wherein said request information for error correction comprises the identification information of said optical disc.

8. The apparatus according to claim 6, wherein said description information comprises at least one of the followings: start address of said error data, end address of said error data, and playing period said error data

9. The apparatus according to claim 6, further comprising:
buffer-storing means for buffer-storing said downloaded backup data.

10. The apparatus according to claim 6, further comprising:
detecting means for detecting the error data in the data read from said optical disc.

11. A network service system for error correction of data in an optical disc, comprising:
receiving means for receiving a request information of error correction of data on an optical disc from a client, wherein said request information of error correction comprises the description information about the error data read from the optical disc;
storing means for storing the backup data corresponding to the data on said optical disc;
retrieving means for retrieving corresponding backup data in said storing means according to said description information; and
sending means for sending said retrieved backup data to said client for replacing said error data, for storing optical disc can be played with said retrieved backup data.

12. The system according to claim 11, wherein said request information of error correction further comprises the identification information of said optical disc.

13. The system according to claim 12, further comprising:
determining means for, based on the identification information of said optical disc, determining whether error correction services should be provided for said optical disc.

14. The system according to claim 11, wherein said description information comprises at least one of the followings: starting address of said error data, ending address of said error data or playing period of the error data.

15. An apparatus for playing an optical disc, comprising:
a reading device for reading optical disc data from an optical disc; and
a device for error correction of the optical disc data, comprising:
detecting means for detecting the error data in the data read from said optical disc;
obtaining means for obtaining the description information about the error data read from said optical disc;
requesting means for sending a request information for error correction, based on said description information, to a network server, wherein said network server stores the backup data corresponding to the data on said optical disc and said request information for error correction comprises a request for downloading the backup data corresponding to said error data; and
replacing means for replacing said error data with said downloaded backup data corresponding to said error data, for playing said optical disc with said optical disc.

16. The apparatus according to claim 15, wherein said description information comprises at least one of the followings: starting address of said error data, ending address of said error data or playing period of said error data.
